(19) United States
(12) Patent Application Publication
(10) Pub. No.: US 2008/0017584 A1
(43) Pub. Date: Jan. 24, 2008

(54) Treatment Fluid Disposal in Chemical Cleaning Processes for Drinking Water Facilities

(76) Inventor: Ulrich Reimann-Philipp, Norman, OK (US)

Correspondence Address: Robin W Asher;Clark Hill, 500 Woodward Avenue, Suite 3500, Detroit, MI, 48226-3435, US

(21) Appl. No.: 11/795,196

(22) PCT Filed: Jan. 12, 2006
(86) PCT No.: PCT/US06/01053

§ 371 Date: Jul. 12, 2007

Related U.S. Application Data
(60) Provisional application No. 60/643,144, filed on Jan. 12, 2005.

(51) Int. Cl. C02F 1/52; C02F 1/66; C02F 1/70

(52) U.S. Cl. 210/719; 210/702

(57) ABSTRACT

A process for the disposal of treatment fluid runoff from drinking water facilities cleaning procedures is disclosed. Due to accumulating sediments, mineral deposits and biological contamination, drinking water tanks and facilities must be cleaned on a regular basis to guarantee water quality and reduce the amount of chlorination required. Various cleaning processes are known, which produce contaminated treatment fluid runoff. The invention provides a runoff disposal process including the principle steps of collecting the runoff in a holding facility, analyzing the pH of the runoff, neutralizing the pH of the runoff with a pH neutralizing agent, and filtering the runoff to remove suspended particulates. Additional steps may include analyzing the chlorine residual in the runoff, and de-chlorinating the runoff with a de-chlorinating agent.

### FIELD OF THE INVENTION

The invention relates in general to drinking water facilities cleaning processes and, in particular, to methods for treatment fluid runoff disposal in processes for the cleaning of drinking water tanks, filters and conduits.

### BACKGROUND ART

Due to accumulating sediments, mineral deposits and biological contamination, drinking water tanks and facilities must be cleaned on a regular basis to guarantee water quality and reduce the amount of chlorination required. Various cleaning processes are known, ranging from purely mechanical processes such as high pressure washing to purely chemical processes such as applying a cleaning solution. Regardless which cleaning procedure is used, contaminated runoff will be produced which must be disposed of safely and in compliance with national and local environmental safety standards. Treatment fluid run-off is currently either collected in exterior storage lagoons or directed into the sewer system, often leading to surface and ground water contamination with chemical, organic or biological pollutants.

In chemical cleaning procedures for drinking water facilities, a liquid treatment solution is normally applied to the surfaces to be cleaned. This creates a runoff of spent treatment solution including particulates removed from the surfaces to be cleaned, dissolved minerals, organic contaminants and biological contaminants. The cleaning reaction runoff is generally colored and turbid and is collected as part of the disposal procedure. Once the cleaning reaction is completed, left over treatment solution, runoff and removed particulates are rinsed off the surfaces to be cleaned with water and the rinsate is collected together with the already captured runoff. The total runoff can then be tested for turbidity, pH, heavy metal content and biological contamination.

Runoff disposal requirements vary by state. In some locals, the runoff can be pumped into a sludge or backwash lagoon, spread on the ground, or simply dumped into the storm sewer. However, progressively tighter environmental regulations will make these disposal options unavailable. Furthermore, certain runoff contaminants can be harmful for the environment. For example, chlorine is a biocide present in the runoff through use of the rinse water or facility disinfection procedures. Also, the runoff can be quite acidic due to the acids in the cleaning chemicals. This is especially a problem in concentrated runoffs. Manganese and Iron are normally present in the runoff as dissolved deposits. They are not toxic in moderate concentrations, but a nuisance through colour formation (red or brown tap water) and precipitation after chlorination. Also, manganese oxides can interfere with chlorine assays. Heavy metals may be toxic at elevated concentrations and should be removed. These metals are generally not introduced through the cleaning chemicals, but can accumulate in the deposits from trace amounts present in the raw water or water treatment chemicals or may have dissolved out of obsolete surface coating materials (lead or arsenic) during the cleaning procedure. All of these heavy metal contaminants can be regulated for storm drain disposal. Otherwise, they must be removed from the runoff to safe concentrations and disposed of in a landfill or hazardous waste facility. The solids of concern for landfill disposal of sediment filtration bags are the same, but generally with much higher limits in mg/kg.

### DESCRIPTION OF THE INVENTION

It is now an object of the present invention to provide a runoff disposal process which overcomes at least one of the contamination problems encountered with prior art disposal processes.

The runoff disposal process of the present invention includes the principle steps of collecting the runoff, analysing the pH of the runoff, neutralizing the runoff and removing metal contaminants. Optional additional steps include de-chlorination of the runoff, collection of particulates removed during the cleaning process, accumulated as sediment in the cleaned facility and flushed into the runoff during rinsing, removal of suspended particulates from the runoff through settling or filtering processes, removal of organic/biological contaminants, or disinfecting of the runoff prior to neutralization. The runoff, when containing unspent treatment fluid, can also be recycled prior to neutralization for continued use in the cleaning process until a predetermined turbidity of the runoff is reached at which point the runoff is subjected to the disposal process of the invention.

To carry out the disposal process of the invention, the runoff is collected in a treatment container or holding facility. In the case of tank or basin cleaning, the runoff can also be collected directly in the cleaned tank or basin which then functions as the holding facility.

The runoff treatment process of the present invention aims at treating the runoff in such a way to make the runoff disposal environmentally responsible and in compliance with existing disposal requirements. In most cases the runoff will be of low pH, turbid and containing chlorine from the rinse water. Dilution or reaction with neutralizing surfaces (concrete, dirt) or deposits (carbonate scale) can be used to raise the pH of the runoff.

In some cases, paint chips and oily or greasy components might be present. The runoff treatment in a preferred embodiment includes the basic steps of:
determining total chlorine concentration in the runoff;
adding de-chlorinating agent and circulating the runoff (preferably using a trash pump) until the chlorine content is <0.1 mg/l;
determining the pH of the runoff;
adding pH neutralizing agent and circulating the runoff until the pH is between 6.5 and 8.5;
pumping the runoff through a filtration dirt bag into a storm sewer or a backwash recycling storage facility; and
disposing of the filtration dirt bag.

Preferred de-chlorinating agents for use in the de-chlorination step include sodium thiosulfate, sodium bisulfite, sodium sulfite, sodium bisulfate, ammonium thiosulfate, ammonium bisulfite, ammonium chloride and ascorbic acid. Other chlorine binding and neutralizing agents are known and can be used as long as they do not impede the safe disposal of the treated runoff.

Preferred pH neutralizing agents for use in the pH neutralizing step include sodium hydroxide (caustic soda; liquid or dry), NaOH solution (f.ex. 25%), calcium hydroxide (hydrated lime; used in many water plants for softening), sodium carbonate (soda ash), magnesium hydroxide, potassium hydroxide (liquid or dry), or any combination thereof. The most preferred neutralizing agents are 25% caustic soda or FLORAN™ Neutralizer. Other pH neutralizing agents are known and can be used as long as they do not impede the safe disposal of the treated runoff.

The runoff treatment process can also include one or more of the following additional steps:
circulating the runoff through the filtration bag back into the holding facility;
collecting samples from the filtered runoff and from the collected solids;
determining the concentrations of soluble contaminants in the filtered runoff and of total concentrations of contaminants in the collected solids;
adjusting contaminant concentrations in the filtered runoff to soluble threshold limits as required by federal, state and local regulations, if necessary;
pumping the filtered runoff into a storm drain, sanitary sewer or recycling water holding facility; and
disposing of the collected solids on a local landfill or as hazardous waste, as required by federal, state and local regulations.

In one embodiment, the basic runoff treatment process includes the following additional steps:
collecting samples of runoff and sediment;
circulating the runoff through a filtration bag and collecting samples;
determining the amount of contaminants (suspended solids, oil, grease, sulfides, residual chlorine, heavy metal content, petroleum hydrocarbons) in the runoff; and

adjusting the runoff composition to the following maximum concentrations:

| | | |
|---|---|---|
| Oil and Grease | 15 | mg/l |
| Sulfides | 0.4 | mg/l |
| Total Residual Chlorine | 0.1 | mg/l |
| Total Suspended Solids | 75 | mg/l |
| Total Petroleum Hydrocarbons | 100 | μg/l. |

Solid Contaminants

Contaminants released from the cleaned surfaces are either contained in dissolved form in the runoff or as solids. By raising the pH of the runoff, a large proportion of the dissolved materials become insoluble and precipitate. These components can be collected with the solids in the filtration bags by once more circulating the runoff after pH adjustment through the filtration bag. It is also possible to run the runoff through straw bales to collect the precipitated out, suspended solids.

Removal of Dissolved (heavy) Metals

During the chemical cleaning process, an acidic runoff is produced. A portion of the organic and inorganic deposits that have been dislodged from the surfaces are present in the form of suspended solids, which are removed through bag filtration. The other portion remains dissolved, as long as the pH remains low. Through raising the pH, these contaminants become less soluble and form a precipitate, which also can be removed by sedimentation or filtration. Our trials have shown that dissolved manganese, iron and arsenic concentrations were greatly reduced by raising the pH to neutral or above. Non-metal contaminants can also be precipitated out of the runoff. By using lime for neutralization, settling of the precipitated materials in a sludge lagoon can be accelerated. Heavy Metal Concentrations should be reduced to the following thresholds or below (in mg/l=ppm): Antimony (15), Arsenic (5), Barium (100), Beryllium (0.75), Cadmium (1), Chromium, VI (5), Chromium, total (560), Cobalt (80), Copper (25), Lead (5), Mercury (0.2), Molybdenum (350), Nickel (20), Selenium (1), Silver (5), Thallium (7), Vanadium (24), Zinc (250). Higher limits apply to solids for landfill disposal.

Biological Contaminants

Biological contaminants in the runoff are preferably neutralized by using chemical cleaners including a disinfectant. If such contaminants are present in the runoff, a cleaning/disinfection solution can be added to the runoff to inactivate and/or kill pathogens present in the runoff or sediment. Organic components include biomass, extra-cellular materials present in biofilms and organic components of carryover flocculation aids.

The process of the present invention is very effective in reducing the dissolved metal concentrations in the runoff. This greatly facilitates recycling of the treated runoff through the filter backwash stream and its disposal into the storm drain.

The present invention is not limited in scope by the specific embodiments described herein. Although the runoff disposal process of the invention has been described above with particular attention to certain exemplary embodiments of the process, various modifications will be apparent to those skilled in the art from the foregoing and the following claims.

1. Process for the disposal of treatment fluid runoff from drinking water facilities cleaning procedures, comprising the steps of
collecting the runoff in a holding facility;
analysing the pH of the runoff;
neutralizing the pH of the runoff with a pH neutralizing agent; and
filtering the runoff to remove suspended particulates.

2. The runoff disposal process as defined in claim 1, comprising the additional steps of
analyzing the chlorine residual in the runoff, and
de-chlorinating the runoff with a de-chlorinating agent.

3. The runoff disposal process as defined in claim 2, comprising the additional steps of
circulating the runoff through a filtration bag;
collect samples of the filtered runoff and the collected solids;
testing the liquid runoff and solids for contaminant concentrations as required by federal, state and local regulations;
lowering the contaminant concentrations to levels acceptable for disposal under local regulations.

4. The runoff disposal process as defined in claim 2, comprising the additional steps of
disposing the treated runoff into the storm sewer.

5. The runoff disposal process as defined in claim 2, comprising the following additional steps:
diverting the treated runoff into a backwash water recycling stream of the drinking water facility.

6. The runoff disposal process as defined in claim 2, comprising the additional steps of
diverting the collected solids to a landfill or hazardous waste collection site in accordance with federal, state and local regulations.

7. The runoff disposal process as defined in claim 1, comprising at least one additional step selected from the group of
removing dissolved heavy metal contaminants;
de-chlorinating the runoff;
collecting particulates removed during the cleaning process and accumulated as sediment in the cleaned facility;
removal of suspended particulates from the treatment solution through settling or filtering processes;
removal of organic/biological contaminants;
disinfecting the runoff prior to neutralization;
recycling the runoff prior to neutralization for continued use in the cleaning process until a predetermined turbidity of the treatment fluid is reached at which the runoff is treated for disposal.

8. The runoff disposal process as defined in claim 2, wherein the de-chlorinating agent is selected from the group of sodium thiosulfate, sodium bisulfite, sodium sulfite, sodium bisulfate, ammonium thiosulfate, ammonium bisulfite, ammonium chloride, ascorbic acid, or any combination thereof.

9. The runoff disposal process as defined in claim 2, wherein the pH neutralizing agent is selected from the group of sodium hydroxide (liquid or dry), NaOH solution, calcium hydroxide, sodium carbonate, magnesium hydroxide, potassium hydroxide (liquid or dry), or any combination thereof.

10. The runoff disposal process as defined in claim 9, wherein the pH neutralizing agent is 25% caustic soda.

11. The runoff disposal process as defined in claim 1, wherein the holding facility
is the treated drinking water facility and the runoff is collected at the bottom of the treated drinking water facility.
